(19) United States
(12) Patent Application Publication
(10) Pub. No.: US 2026/0057138 A1
(43) Pub. Date: Feb. 26, 2026

(54) DEVICE DESIGN ASSISTANCE METHOD AND DEVICE DESIGN ASSISTANCE APPARATUS

(71) Applicant: JGC CORPORATION, Kanagawa (JP)

(72) Inventors: Yuki MIHARA, Kanagawa (JP); Nobuharu SEKI, Kanagawa (JP); Shun MIKAMI, Kanagawa (JP); Yutaro ITAGAKI, Kanagawa (JP)

(73) Assignee: JGC CORPORATION, Kanagawa (JP)

(21) Appl. No.: 19/108,170

(22) PCT Filed: Nov. 25, 2022
(86) PCT No.: PCT/JP2022/043617

§ 371 Date: Mar. 2, 2025

(51) Int. Cl. G06F 30/20; G06F 30/13; G06F 113/14; G06F 119/18

(52) U.S. Cl. CPC G06F 30/20; G06F 30/13; G06F 2113/14; G06F 2119/18

(57) ABSTRACT

Provided are a device design assistance method and device design assistance apparatus. The device design assistance method includes: a model generation step of generating, after receiving device design data including a design shape relating to structural design of a device to be installed in a plant, a three-dimensional model based on the device design data; a first model update step of updating, after receiving device manufacturing data including a change content with respect to the design shape regarding manufacturing of the device, the three-dimensional model based on the device manufacturing data to generate a three-dimensional model; and a second model update step of updating, after receiving device connection data including a change content with respect to the design shape regarding connection to a peripheral device installed around the device in the plant, the three-dimensional model based on the device connection data to generate a three-dimensional model.

### TECHNICAL FIELD

The present invention relates to a device design assistance method and a device design assistance apparatus.

### BACKGROUND ART

In design of a plant, a wide variety of drawings are created in work of designing the entire plant and work of designing a large number of devices to be installed in the plant. In addition, the drawing created in each piece of design work is widely used from manufacture and installation of each device to also construction and maintenance of the plant. Accordingly, in order to simplify and increase efficiency of each piece of design work, discussions have been made to introduce a three-dimensional model which represents shapes of the entire plant and devices in three-dimensional shapes such as those described in Patent Literature 1 and Patent Literature 2.

### CITATION LIST

### Patent Literature

[Patent Literature 1]: JP 2009-223654 A
[Patent Literature 2]: US 2021/0034319 A1

### SUMMARY OF INVENTION

### Technical Problem

In the work of designing the device to be installed in the plant, a plurality of designers having different responsible ranges of design targets are involved to determine a final design shape of the device. For example, a designer belonging to a structural design department of a building contractor of the plant (for example, a plant manufacturer, a plant engineering company, or the like) performs structural design of the device so as to meet requirements of a process executed in the plant. Then, a designer belonging to a manufacturer of the device (for example, a device vendor or the like) makes changes to the design shape of the device for which the structural design has been performed in consideration of manufacturing of the device. Further, a designer belonging to a piping design department of the plant building contractor makes changes in consideration of connection to a peripheral device arranged around the device. In this manner, the final design shape of the device is determined. Accordingly, in order to introduce the three-dimensional model representing the shape of the device in the work of designing the device, it is required to be capable of appropriately responding to a situation in which a plurality of designers make additive or gradual changes to the design shape as described above.

The present invention has been made in view of the above-mentioned problems, and has an object to provide a device design assistance method and a device design assistance apparatus with which contents of design work performed additionally or gradually by a plurality of designers can be sequentially consolidated to a three-dimensional model.

### Solution to Problem

In order to achieve the above-mentioned object, a device design assistance method according to one aspect of the present invention includes: a model generation step of generating, after receiving device design data including a design shape relating to structural design of a device to be installed in a plant, a three-dimensional model representing a shape of the device based on the device design data; a first model update step of updating, after receiving device manufacturing data including a change content with respect to the design shape regarding manufacturing of the device, the three-dimensional model by reflecting the device manufacturing data in the shape; and a second model update step of updating, after receiving device connection data including a change content with respect to the design shape regarding connection to a peripheral device installed around the device in the plant, the three-dimensional model by reflecting the device connection data in the shape.

### Advantageous Effects of Invention

With the device design assistance method according to the one aspect of the present invention, in the model generation step, the three-dimensional model is generated based on the device design data including the design shape relating to the structural design of the device. In the first model update step, the three-dimensional model is updated based on the device manufacturing data including the change content regarding the manufacturing of the device. In the second model update step, the three-dimensional model is updated based on the device connection data including the change content regarding the connection to the peripheral device. Thus, the contents of the design work performed additionally or gradually by the plurality of designers regarding the structural design of the device, the manufacturing of the device, and the connection to the peripheral device can be sequentially consolidated to the three-dimensional model.

Problems, configurations, and effects other than those described above become apparent in the Description of Embodiments section described later.

### BRIEF DESCRIPTION OF DRAWINGS

FIG. 1 is an overall diagram for illustrating an example of a plant design assistance system 1 and a plant 10.

FIG. 2 is a block diagram for illustrating an example of a device design assistance apparatus 2.

FIG. 3 is a data configuration diagram for illustrating an example of a plant design database 5.

FIG. 4 is a data configuration diagram for illustrating an example of device basic data 53, device design data 54, device manufacturing data 55, and device connection data 56.

FIG. 5 is a data configuration diagram for illustrating an example of a three-dimensional model 57.

FIG. 6 is a function explanatory diagram for illustrating an example of the device design assistance apparatus 2.

FIG. 7 is a hardware configuration diagram for illustrating an example of a computer 900 forming each of the device design assistance apparatus 2 and terminal apparatus 3A to 3C.

FIG. 8 is a flow chart for illustrating an example of an operation of the plant design assistance system 1.

FIG. 9 is a flow chart for illustrating an example of the operation of the plant design assistance system 1 (continuation of FIG. 8).

FIG. 10 is a flow chart for illustrating an example of the operation of the plant design assistance system 1 (continuation of FIG. 9).

FIG. 11 is a flow chart for illustrating an example of the operation of the plant design assistance system 1 (continuation of FIG. 10).

FIG. 12 is a view for illustrating an example of a three-dimensional model display screen 6A for displaying an initial three-dimensional model 57A.

FIG. 13 is a view for illustrating an example of a three-dimensional model display screen 6B for displaying an updated three-dimensional model 57B updated based on the device manufacturing data 55.

FIG. 14 is a view for illustrating an example of a three-dimensional model display screen 6C for displaying an updated three-dimensional model 57C updated based on the device connection data 56.

FIG. 15 is a view for illustrating an example of a three-dimensional model display screen 6C (model display region 61C) for displaying a wire movable range 612.

### DESCRIPTION OF EMBODIMENTS

Embodiments for carrying out the present invention are described below with reference to the drawings. In the following description, a range required for the description for achieving the object of the present invention is schematically shown, and a range required for the description of a portion corresponding to the present invention is mainly described. A portion of which the description is omitted is based on a known technology.

### Configuration of Plant Design Assistance System 1

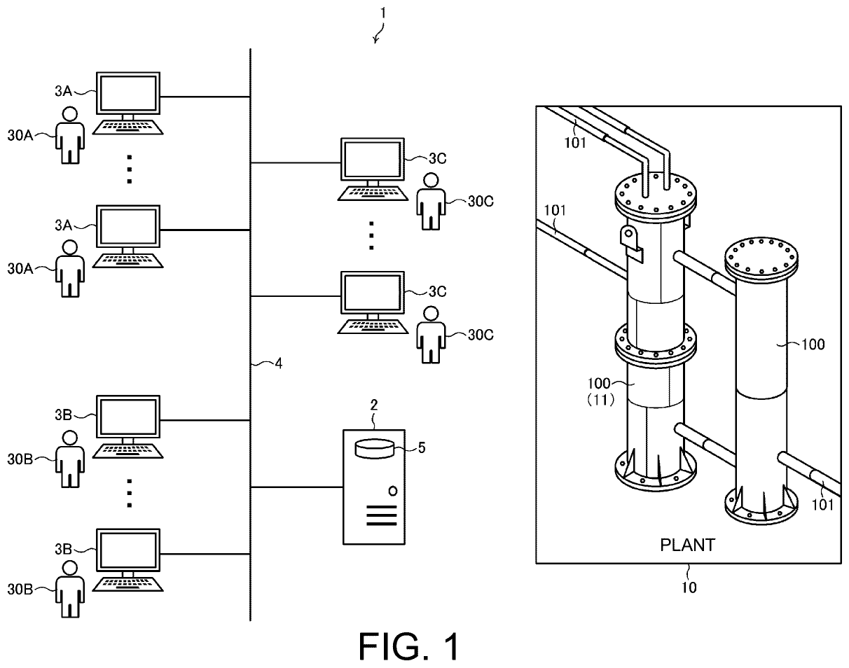

FIG. 1 is an overall diagram for illustrating an example of a plant design assistance system 1 and a plant 10. The plant design assistance system 1 functions as a system for assisting in structural design of a device 100 installed in the plant 10. The plant 10 is, for example, any plant, such as a natural gas plant, a petroleum refinery plant, a chemical processing plant, a power generation plant, or a steel plant, and is not limited to those examples.

The plant 10 has installed therein, for example, various devices 100 for processing any fluid, such as gas, liquid, or a granular material having flowability, piping 101 for connecting the devices 100 to each other to form a flow path of the fluid, various instruments (not shown) including a flow rate sensor, a pressure sensor, a temperature sensor, and the like, and various controllers (not shown) including a valve, a pump, a compressor, a controller, and the like, to thereby perform a predetermined manufacturing process. Examples of the device 100 include heat exchangers and columns and tanks for performing reaction, distillation, extraction, absorption, cleaning, flow rate adjustment, temperature adjustment, and the like. In this embodiment, description is mainly given of a case in which the device 100 is a vertically-placed pressure vessel 11 illustrated in FIG. 1.

The plant design assistance system 1 includes, as main components thereof, a device design assistance apparatus 2 for assisting in structural design of the device 100, a terminal apparatus 3A for a structural designer 30A who performs basic structural design of the device 100, a terminal apparatus 3B for a device manufacturing designer 30B who performs design regarding manufacturing of the device 100, and a terminal apparatus 3C for a device connection designer 30C who performs design regarding connection to a peripheral device installed around the device 100 in the plant 10. Description is mainly given of the following case: the structural designer 30A belongs to a structural design department of a building contractor of the plant 10 (for example, a plant manufacturer, a plant engineering company, or the like), the device manufacturing designer 30B belongs to a device design department of a manufacturer of the device 100 (for example, a device vendor or the like), and the device connection designer 30C belongs to a piping design department of the building contractor of the plant 10, but the departments to which the respective designers 30A to 30C belong are not limited to those examples.

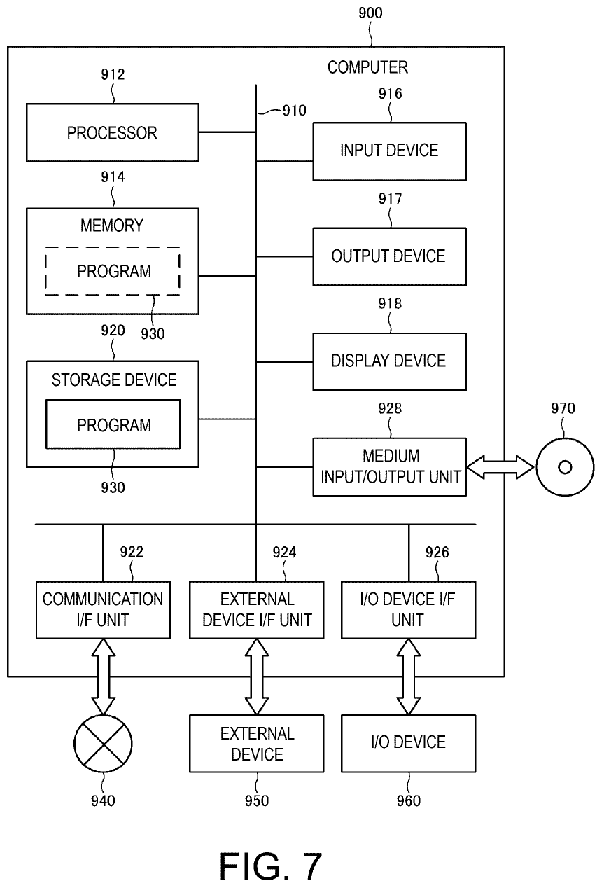

Each of the device design assistance apparatus 2 and the terminal apparatus 3A to 3C is formed of, for example, a general-purpose or dedicated computer (see FIG. 7 to be referred to later), and is connected to a wired or wireless network 4 so as to allow mutual transmission and reception of various types of data. The number of the device design assistance apparatus 2, the number of the terminal apparatus 3A to 3C, and the configuration of the network 4 are not limited to those in the example of FIG. 1.

The device design assistance apparatus 2 is formed of, for example, a server-type computer or a cloud-type computer. The device design assistance apparatus 2 includes a plant design database 5 for managing plant design information of the plant 10. In this embodiment, description is mainly given of a configuration and an operation at the time when the device design assistance apparatus 2 cooperates with the terminal apparatus 3A to 3C to assist in the structural design of the device 100 as part of the overall design of the plant 10, but the device design assistance apparatus 2 and the terminal apparatus 3A to 3C may assist in basic design or detail design other than the structural design of the device 100.

The terminal apparatus 3A to 3C are each formed of, for example, a stationary-type computer or a portable-type computer, and are used by designers 30A to 30C, respectively. Each of the terminal apparatus 3A to 3C has a program, such as an application or a browser, installed therein, and receives various input operations and further outputs various types of information via a display screen or sound. Each of the terminal apparatus 3A to 3C transmits or receives various types of data to or from the device design assistance apparatus 2. Thus, each of the terminal apparatus 3A to 3C assists in the structural design of the device 100 by, for example, displaying contents of the plant design database 5 on a display screen, and receiving various input operations on this display screen to register new data in the plant design database 5 or to correct the registered data

### Configuration of Device Design Assistance Apparatus 2

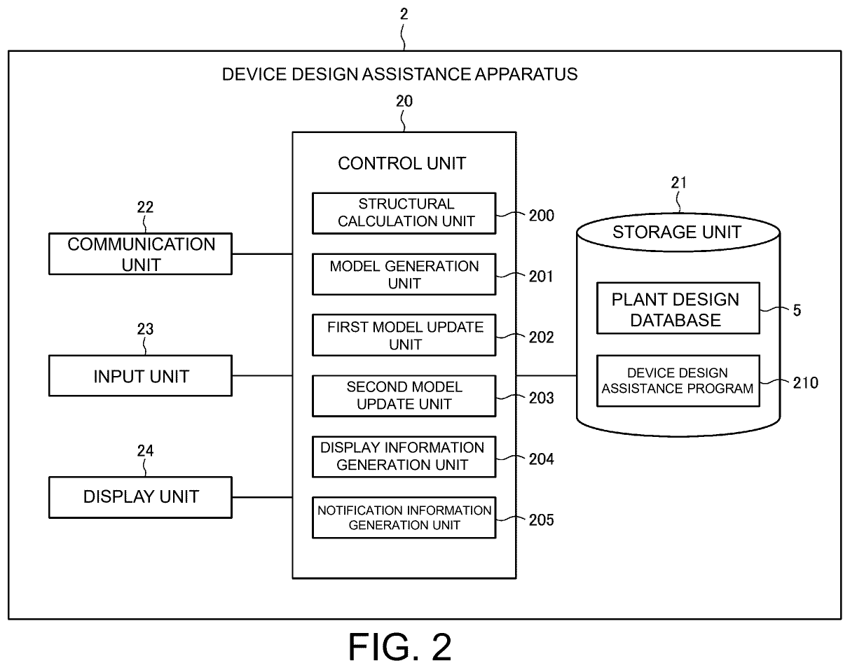

FIG. 2 is a block diagram for illustrating an example of the device design assistance apparatus 2. The device design assistance apparatus 2 includes a control unit 20, a storage unit 21, a communication unit 22, an input unit 23, and a display unit 24. The control unit 20 is formed of a processor or the like. The storage unit 21 is formed of an HDD, an SSD, a memory, or the like. The communication unit 22 serves as a communication interface with respect to the network 4. The input unit 23 is formed of a keyboard, a mouse, or the like. The display unit 24 is formed of a display or the like. The input unit 23 and the display unit 24 may be omitted.

The storage unit 21 stores the plant design database 5 and a device design assistance program 210, and also stores an operating system, other programs, various types of data, and the like.

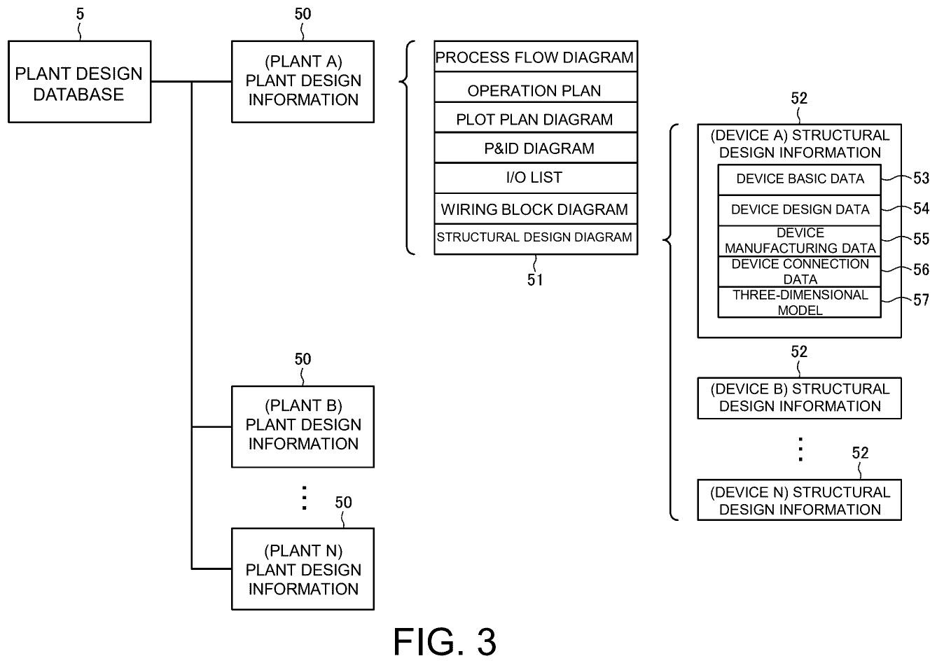

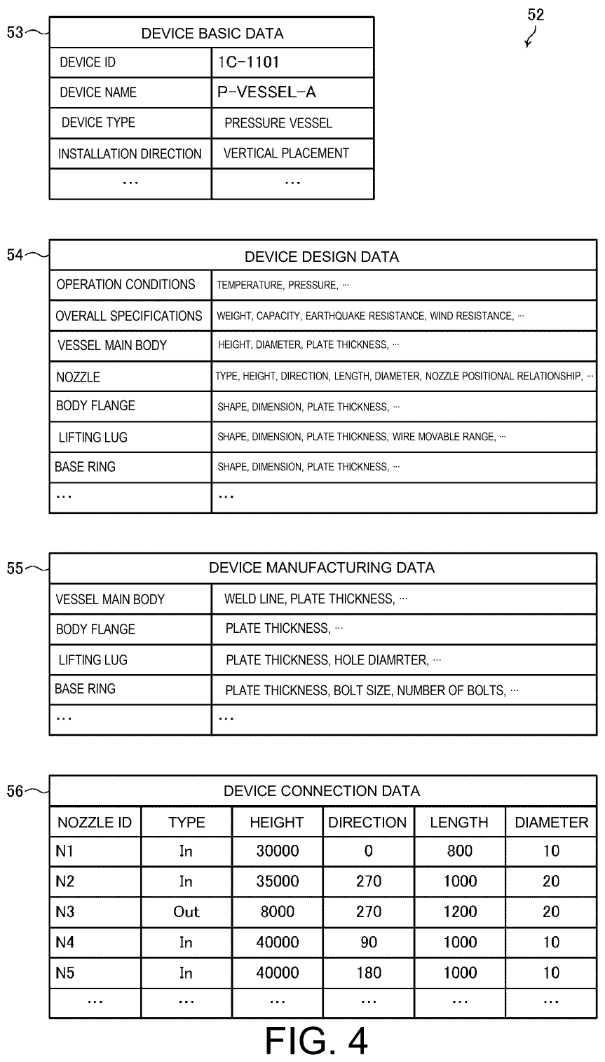

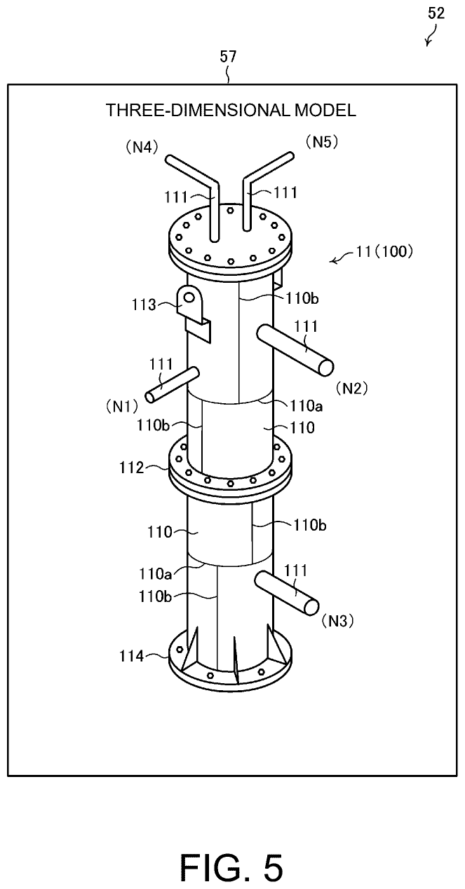

FIG. 3 is a data configuration diagram for illustrating an example of the plant design database 5. FIG. 4 and FIG. 5 are data configuration diagrams for illustrating an example of structural design information 52. The plant design database 5 is a database for storing plant design information 50 which is design data of each plant 10 (in the example of FIG. 3, each of plants A, B, . . . , and N), for each plant 10.

The plant design information 50 is generated by work of designing the plant 10. The plant design information 50 is formed of, for example, a process flow diagram, an operation plan, a plot plan diagram, a piping & instrumentation diagram (P&ID diagram), an input/output (I/O) list, a wiring block diagram, a structural design diagram 51, and the like. For each of the device 100, the piping 101, the instruments, the controllers, and the like installed in the plant 10, for example, identification information called an identification number, an identification code, an identification name, an identification tag, or the like (numbers, letters, or a combination thereof) is given. The identification information is used in each of the drawings forming the plant design information 50 so that pieces of information in the drawings are associated with each other.

The structural design diagram 51 stores the structural design information 52 which is design data relating to the structural design of each device 100 (in the example of FIG. 3, each of the devices A, B, . . . , and N), for each device 100. The structural design information 52 includes device basic data 53, device design data 54, device manufacturing data 55, device connection data 56, and a three-dimensional model 57.

The device basic data 53 is data including basic features of the device 100. The device basic data 53 includes, for example, a device ID, a device name, a device type, an installation direction, and the like indicating the identification information of the device 100.

When the device type and the installation direction are the vertically-placed pressure vessel 11, the pressure vessel 11 includes, as components thereof, as illustrated in FIG. 5, a cylindrical vessel main body 110, a plurality of nozzles 111, a body flange 112, a lifting lug (hoisting hardware) 113, and a base ring 114. The plurality of nozzles 111 extend in predetermined directions from predetermined heights of the vessel main body 110, and are provided to be connected to peripheral devices. The body flange 112 is provided to couple the vessel main body 110 in an axial direction. The lifting lug (hoisting hardware) 113 is provided to hoist the device 100 with a wire member when the device 100 is installed in the plant 10. The base ring 114 is provided to fix the vessel main body 110 to an installation surface of the plant 10. The pressure vessel 11 may include other components. When the device 100 is a device 100 other than the pressure vessel 11, the device 100 includes various components depending on the device type and the installation direction.

The device design data 54 is data including a design shape relating to the structural design of the device 100. When the device 100 is the vertically-placed pressure vessel 11, the device design data 54 includes, for example, operation conditions of the pressure vessel 11, the overall specifications, and shapes, dimensions, plate thicknesses, and the like of the components 110 to 114 (vessel main body 110, nozzles 111, body flange 112, lifting lug 113, and base ring 114).

The device design data 54 may include, for the nozzles 111, a nozzle positional relationship which determines a relative positional relationship between specific nozzles 111 out of the plurality of nozzles 111. The nozzle positional relationship is defined based on an allowable range determined as follows. For example, the plurality of nozzles 111 are grouped, and the allowable range is determined by at least one of an upper limit or a lower limit with respect to a height difference which is caused by a difference in height of the nozzles 111 or with respect to an angle difference which is caused by a difference in direction of the nozzles 111 in the plurality of nozzles 111 included in the same group.

Further, the device design data 54 may include, for the lifting lug 113, a hoisting hardware position indicating the position of the lifting lug 113 for use in hoisting the device 100 with the wire member when the device 100 is installed in the plant 10, and a wire movable range indicating a range in which the wire member is movable with reference to the hoisting hardware position.

The device manufacturing data 55 is data including a change content with respect to the design shape of the device 100 regarding manufacturing of the device 100. When the device 100 is the vertically-placed pressure vessel 11, the device manufacturing data 55 includes at least one of a weld line of the vessel main body 110 in the pressure vessel 11 (in FIG. 5, reference symbol 110a indicates a weld line along a circumferential direction, and reference symbol 110b indicates a weld line along the axial direction) or the plate thickness of the vessel main body 110. The plate thickness of the vessel main body 110 is also included in the device design data 54, but is treated as one further updated with the value included in the device manufacturing data 55. Further, the device manufacturing data 55 may include other parameters of the vessel main body 110, or may include a shape, a dimension, and a plate thickness of the body flange 112, a plate thickness and a hole diameter of the lifting lug 113, a plate thickness, a bolt size, and the number of bolts of the base ring 114, and the like.

The device connection data 56 is data including a change content with respect to the design shape of the device 100 regarding connection to a peripheral device (such as another device 100 or the piping 101) installed around the device 100. When the device 100 is the vertically-placed pressure vessel 11, the device connection data 56 includes a type of the nozzle 111 (such as input or output), a nozzle position indicating the position of the nozzle 111 (such as a height and a direction (orientation)), a length, a diameter, and the like. The type of the nozzle 111, the nozzle position, the length, and the diameter are also included in the device design data 54, but are treated as ones further updated with the values included in the device connection data 56.

The three-dimensional model 57 is data representing the three-dimensional shape of the device 100. The three-dimensional model 57 is data that allows the three-dimensional shape to be displayed in any viewpoint, scale, transparency, or display color, and is formed as data that can be converted into a projection view, a sectional view, and the like. The three-dimensional model 57 is generated based on the device design data 54, and is updated by reflecting the change content included in each of the device manufacturing data 55 and the device connection data 56 in the shape of the device 100. The three-dimensional model 57 may be subjected to, for example, version control (version management) so that the three-dimensional models 57 before and after the update may be included in the structural design diagram 51.

Each diagram forming the plant design information 50 is referred to by the terminal apparatus 3A to 3C so that, on display screens of the terminal apparatus 3A to 3C, editing operations such as addition, deletion, and correction of each piece of data are performed by the designers 30A to 30C. At this time, in the work of referring to or editing the plant design database 5, authority control is performed based on the permission authority of each of the designers 30A to 30C. The data configuration of each diagram forming the plant design information 50 is not limited to the example described above, and may be changed as appropriate. Part of the data described above may be omitted, or data other than the above-mentioned data may be added. Further, the plant design information 50 can adopt any data format. For example, an XML format or a CAD format may be adopted, or a plurality of data formats may be combined with each other as appropriate.

As illustrated in FIG. 2, the control unit 20 executes the device design assistance program 210 stored in the storage unit 21 to function as a structural calculation unit 200, a model generation unit 201, a first model update unit 202, a second model update unit 203, a display information generation unit 204, and a notification information generation unit 205. The units 200 to 205 of the control unit 20 function as a user interface with respect to the designers 30A to 30C who perform the structural design of the device 100 by transmitting, to the terminal apparatus 3A to 3C, display information for use in causing the terminal apparatus 3A to 3C to display various display screens, and receiving various input operations performed by the designers 30A to 30C via the display screens.

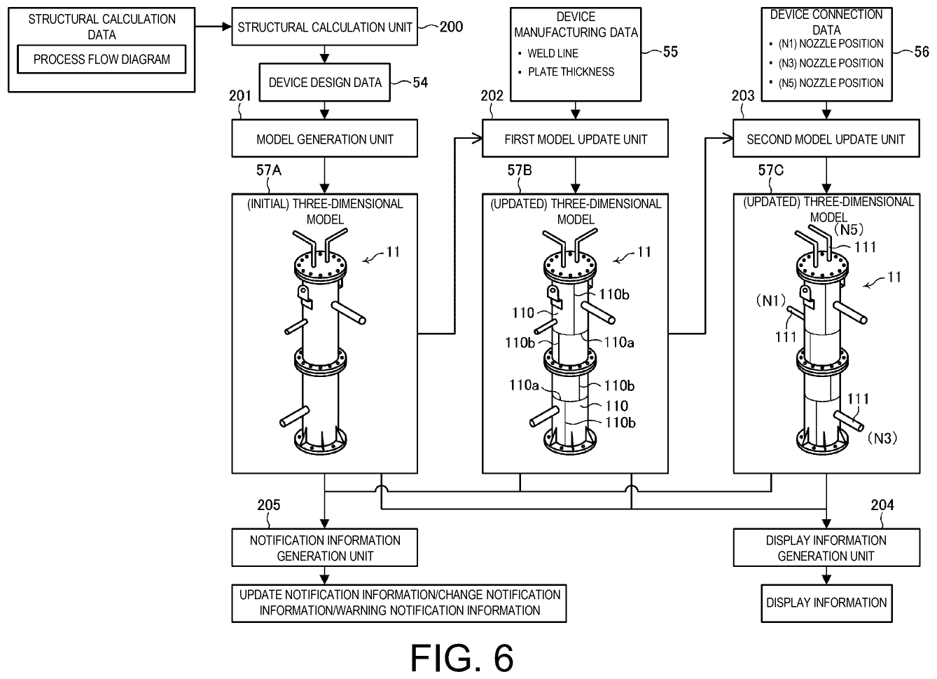

FIG. 6 is a function explanatory diagram for illustrating an example of the device design assistance apparatus 2. FIG. 6 shows a case in which the device 100 is the vertically-placed pressure vessel 11 similarly to FIG. 4 and FIG. 5.

The structural calculation unit 200 receives the process flow diagram and the like included in the plant design information 50 as structural calculation data to perform structural calculation of each device 100 based on the structural calculation data, to thereby generate the device design data 54 of each device 100 as a result of the structural calculation. For example, when the structural calculation unit 200 receives, from the terminal apparatus 3A operated by the structural designer 30A, an input operation of specifying structural calculation data of a plant 10 that becomes the target of the structural design, the structural calculation unit 200 generates the device design data 54 of each device 100 based on the structural calculation data.

The model generation unit 201 receives the device design data 54, and generates an initial three-dimensional model 57A of the device 100 based on the device design data 54. For example, when the model generation unit 201 receives, from the terminal apparatus 3A operated by the structural designer 30A, an input operation of specifying the device design data 54 of the pressure vessel 11 as the device 100 that becomes the target of the structural design, the model generation unit 201 generates the initial three-dimensional model 57A of the pressure vessel 11 based on the design shape relating to the structural design of the pressure vessel 11 included in the device design data 54.

The first model update unit 202 receives the device manufacturing data 55 including the change content with respect to the design shape regarding the manufacturing of the device 100, and updates the three-dimensional model 57A by reflecting the device manufacturing data 55 in the three-dimensional shape. For example, when the first model update unit 202 receives, from the terminal apparatus 3B operated by the device manufacturing designer 30B, an input operation of specifying the change content of the design shape regarding the manufacturing of the device 100 (for example, the weld lines 110a and 110b and the plate thickness of the vessel main body 110) as the device manufacturing data 55, the first model update unit 202 updates the initial three-dimensional model 57A by reflecting the device manufacturing data 55 in the three-dimensional shape to generate an updated three-dimensional model 57B. FIG. 6 shows a case in which the device manufacturing data 55 includes the change content of setting the weld lines 110a and 110b of the vessel main body 110 and changing the plate thickness of the vessel main body 110.

The second model update unit 203 receives the device connection data 56 including the change content with respect to the design shape regarding the connection to the peripheral device installed around the device 100, and updates the three-dimensional model 57A by reflecting the device connection data 56 in the shape. For example, when the second model update unit 203 receives, from the terminal apparatus 3C operated by the device connection designer 30C, an input operation of specifying the change content of the design shape regarding the connection to the peripheral device (for example, the nozzle position of each nozzle 111) as the device connection data 56, the second model update unit 203 updates the updated three-dimensional model 57B (which may be the initial three-dimensional model 57A) by reflecting the device connection data 56 in the three-dimensional shape to generate an updated three-dimensional model 57C. FIG. 6 shows a case in which the device connection data 56 includes the change content of changing the nozzle positions of the nozzles 111 identified by the nozzle IDs of N1, N3, and N5.

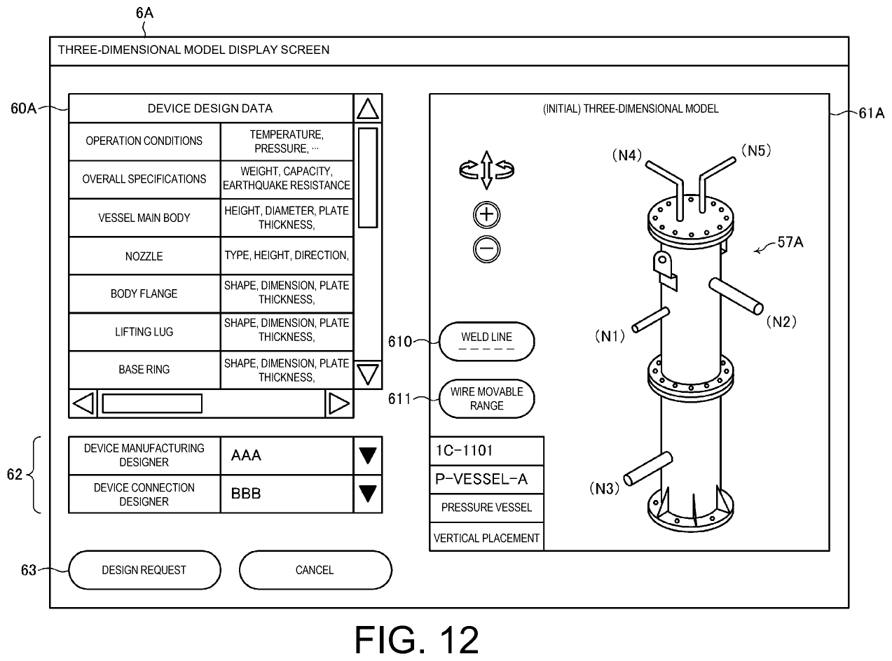

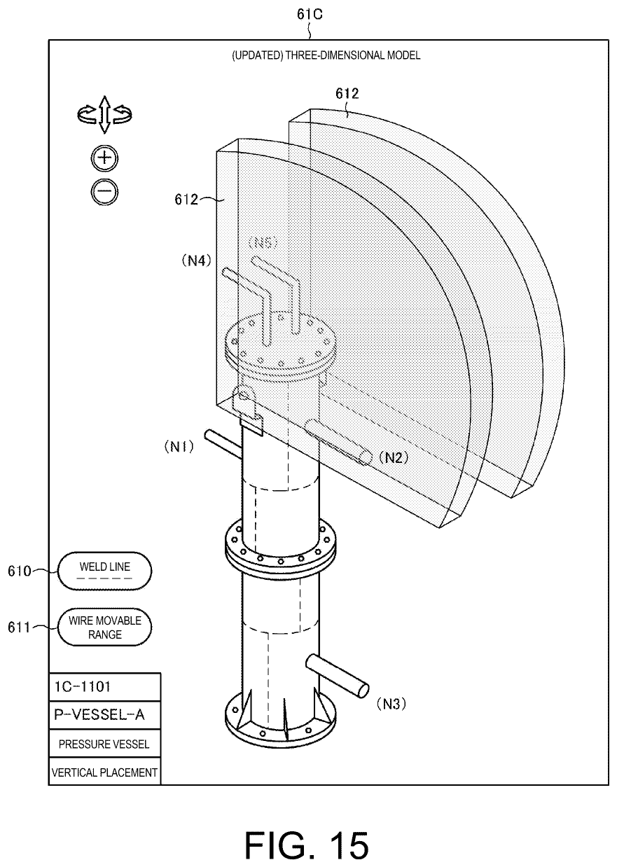

The display information generation unit 204 generates display information for displaying the three-dimensional model 57A generated by the model generation unit 201 or the three-dimensional model 57B or 57C updated by at least one of the first model update unit 202 or the second model update unit 203 on, for example, the display screens of the terminal apparatus 3A to 3C (see FIG. 12 to FIG. 14 to be referred to later). At this time, the display information generation unit 204 may generate the display information for displaying the shape of the device 100 and the wire movable range in a distinguishable manner on the display screen (see FIG. 15 to be referred to later).

The notification information generation unit 205 generates update notification information and change notification information. The update notification information is used to notify the terminal apparatus 3 A used by a provider of the device design data 54 of the change content included in the device manufacturing data 55 or the device connection data 56. The change notification information is used to notify the terminal apparatus 3B or 3C used by a provider of at least one of the device manufacturing data 55 or the device connection data 56 of the change content made when the design shape is changed in the structural design.

Further, the notification information generation unit 205 checks the data consistency among the device design data 54, the device manufacturing data 55, and the device connection data 56, and generates warning notification information when there is no consistency. The warning notification information is used to warn one of the terminal apparatus 3 A to 3C used by the provider of the device design data 54, the device manufacturing data 55, or the device connection data 56 of the fact that there is no consistency.

As the data consistency, between the device design data 54 and the device manufacturing data 55, for example, it is checked whether the plate thickness of the vessel main body 110 and the plate thickness of the base ring 114 in the device manufacturing data 55 satisfy earthquake resistance or wind resistance in the device design data 54. Between the device design data 54 and the device connection data 56, for example, it is checked whether the nozzle position of each nozzle 111 in the device connection data 56 satisfies the nozzle positional relationship in the device design data 54 (for example, whether the height difference between heights of the two nozzles 111 identified by the nozzle IDs of N2 and N3 falls within the allowable range of from 25,000 to 35,000, or whether the angle difference between directions of the two nozzles 111 identified by the nozzle IDs of N2 and N4 is 180 degrees (allowable range)). Between the device manufacturing data 55 and the device connection data 56, for example, it is checked whether the weld lines 110a and 110b of the vessel main body 110 in the device manufacturing data 55 interfere with the nozzle position of each nozzle 111 in the device connection data 56.

A part or the whole of the plant design database 5 may be stored in an external apparatus (which may be a plurality of external apparatus) or any storage medium connectable to the network 4. In this case, the units 200 to 205 of the control unit 20 may acquire the plant design information 50 from this external apparatus via the network 4 and the communication unit 22, or may acquire the plant design information 50 from this storage medium.

FIG. 7 is a hardware configuration diagram for illustrating an example of a computer 900 forming each of the device design assistance apparatus 2 and the terminal apparatus 3A to 3C.

Each of the device design assistance apparatus 2 and the terminal apparatus 3A to 3C is formed of a general-purpose or dedicated computer 900. The computer 900 includes, as illustrated in FIG. 7, as main components thereof, a bus 910, a processor 912, a memory 914, an input device 916, an output device 917, a display device 918, a storage device 920, a communication interface (I/F) unit 922, an external device I/F unit 924, an input/output (I/O) device I/F unit 926, and a medium input/output unit 928. The above-mentioned components may be omitted as appropriate in accordance with the application in which the computer 900 is used.

The processor 912 is formed of one or a plurality of arithmetic processing units (central processing unit (CPU), micro-processing unit (MPU), digital signal processor (DSP), graphics processing unit (GPU), and the like), and operates as a control unit for controlling the overall computer 900. The memory 914 stores various types of data and a program 930, and is formed of, for example, a volatile memory (DRAM, SRAM, or the like) functioning as a main memory, and a non-volatile memory (ROM), a flash memory, or the like.

The input device 916 is formed of, for example, a keyboard, a mouse, numeric keys, or an electronic pen, and functions as an input unit. The output device 917 is formed of, for example, a sound (voice) output device or a vibration device, and functions as an output unit. The display device 918 is formed of, for example, a liquid crystal display, an organic EL display, an electronic paper display, or a projector, and functions as the output unit. The input device 916 and the display device 918 may be integrally formed like a touch panel display. The storage device 920 is formed of, for example, an HDD or an SSD, and functions as a storage unit. The storage device 920 stores various types of data required for executing the operating system or the program 930.

The communication I/F unit 922 is connected in a wired or wireless manner to a network 940 (which may be the same as the network 4 of FIG. 1), such as the Internet or an intranet, and functions as a communication unit for transmitting and receiving data to and from other computers in accordance with a predetermined communication standard. The external device I/F unit 924 is connected in a wired or wireless manner to an external device 950, such as a camera, a printer, a scanner, or a reader/writer, and functions as a communication unit for transmitting and receiving data to and from the external device 950 in accordance with a predetermined communication standard. The I/O device I/F unit 926 is connected to an I/O device 960, such as various sensors or actuators, and functions as a communication unit for transmitting and receiving, for example, various signals, such as a detection signal obtained by a sensor or a control signal output to an actuator, and data to and from the I/O device 960. The medium input/output unit 928 is formed of, for example, a drive device, such as a digital versatile disc (DVD) drive or a compact disc (CD) drive, a memory card slot, or a USB connector, and reads data from or writes data to a medium (non-transitory storage medium) 970, such as a DVD, a CD, a memory card, or a USB memory.

In the computer 900 having the above-mentioned configuration, the processor 912 invokes the program 930 stored in the storage device 920 into the memory 914 to execute the program 930, to thereby control each unit of the computer 900 via the bus 910. The program 930 may be stored in the memory 914 instead of being stored in the storage device 920. The program 930 may be stored in the medium 970 in an installable file format or an executable file format, and may be provided to the computer 900 via the medium input/output unit 928. The program 930 may be provided to the computer 900 by being downloaded via the network 940 through the communication I/F unit 922. Further, the computer 900 may implement various functions to be implemented by the processor 912 executing the program 930 by, for example, hardware, such as a field-programmable gate array (FPGA) or an application specific integrated circuit (ASIC).

The computer 900 is formed of, for example, a stationary-type computer or a portable-type computer, and is an electronic device in any mode. The computer 900 may be a client-type computer, a server-type computer, or a cloud-type computer.

### Operation of Plant Design Assistance System 1

Now, a series of operations performed by the plant design assistance system 1 is described. The series of operations is executed by each unit of the device design assistance apparatus 2 (each step of a device design assistance method executed by the device design assistance program 210) and the terminal apparatus 3A to 3C cooperating with each other.

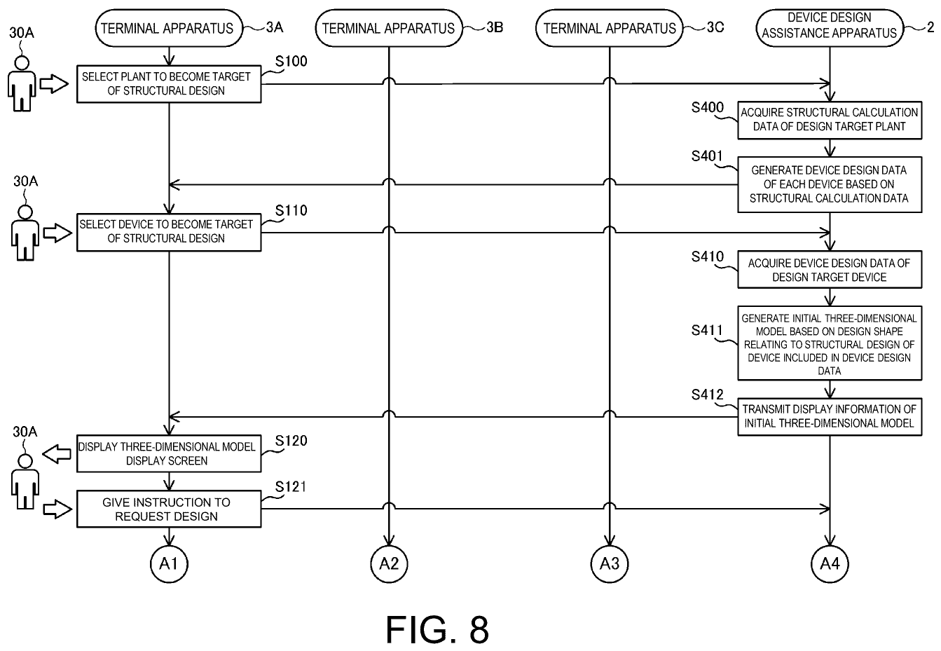

FIG. 8 to FIG. 11 are flow charts for illustrating an example of the operation of the plant design assistance system 1. In the following, description is given of a case in which structural design is performed for the vertically-placed pressure vessel 11 as an example of the device 100.

First, in Step S100, for example, when the terminal apparatus 3 A operated by the structural designer 30A is given an instruction to select the plant 10 to be the target of the structural design as an input operation performed by the structural designer 30A on the display screen, the terminal apparatus 3A transmits instruction information that is based on the input operation to the device design assistance apparatus 2.

Next, in Step S400, when the structural calculation unit 200 of the device design assistance apparatus 2 receives the instruction information from the terminal apparatus 3A, the structural calculation unit 200 refers to the plant design database 5 and acquires the structural calculation data (process flow diagram and the like) included in the plant design information 50 of the design target plant relating to the instruction information. In addition, in Step S401, the structural calculation unit 200 generates the device design data 54 of each device 100 based on the structural calculation data to register the device design data 54 in the plant design database 5, and transmits this fact to the terminal apparatus 3A.

Next, in Step S110, for example, when the terminal apparatus 3A is given an instruction to select the device 100 to become the target of the structural design as an input operation performed by the structural designer 30A on the display screen (in the following, description is given assuming that the device 100 is the vertically-placed pressure vessel 11), the terminal apparatus 3A transmits instruction information that is based on the input operation to the device design assistance apparatus 2.

Next, in Step S410, when the model generation unit 201 receives the instruction information from the terminal apparatus 3A, the model generation unit 201 refers to the plant design database 5, and acquires the device design data 54 of the pressure vessel 11 that is the design target device relating to the instruction information. In addition, in Step S411, the model generation unit 201 generates the initial three-dimensional model 57A of the pressure vessel 11 based on the design shape relating to the structural design of the pressure vessel 11 included in the device design data 54, and registers the initial three-dimensional model 57A in the plant design database 5.

Next, in Step S412, the display information generation unit 204 generates display information for displaying the initial three-dimensional model 57A generated by the model generation unit 201, and transmits the display information to the terminal apparatus 3A. In addition, in Step S120, the terminal apparatus 3A displays a three-dimensional model display screen 6A based on this display information.

FIG. 12 is a view for illustrating an example of the three-dimensional model display screen 6A displaying the initial three-dimensional model 57A. The three-dimensional model display screen 6A includes a data display region 60A for displaying the device design data 54, a model display region 61A for displaying the initial three-dimensional model 57A, a designer selection region 62 for selecting each of the device manufacturing designer 30B and the device connection designer 30C, and a design request button 63 for requesting the design from the device manufacturing designer 30B and the device connection designer 30C selected in the designer selection region 62.

The model display region 61A is formed to be capable of displaying dimensions of each portion of the pressure vessel 11, and includes a weld line button 610 and a wire movable range button 611. The weld line button 610 is provided to display the weld lines 110a and 110b in superimposition with the three-dimensional model 57A, and the wire movable range button 611 is provided to display the wire movable range in superimposition with the three-dimensional model 57A. The data display region 60A may be capable of displaying data other than the device design data 54, or may be capable of displaying each diagram forming the plant design information 50. Further, the model display region 61A may allow designation of the nozzle 111 to be displayed, or may allow filtering the nozzle 111 to be displayed by receiving designation of at least one of the upper limit or the lower limit with respect to the height or the direction of the nozzle 111.

The structural designer 30A visually recognizes the shape of the pressure vessel 11 displayed in the model display region 61A of the three-dimensional model display screen 6A. Then, when the structural designer 30A inputs an instruction to request the design for the manufacturing of the pressure vessel 11 from the device manufacturing designer 30B and an instruction to request the design for the connection to the peripheral device of the pressure vessel 11 from the device connection designer 30C through use of the designer selection region 62 and the design request button 63, in Step S121, the terminal apparatus 3A transmits instruction information that is based on the input operation to the device design assistance apparatus 2.

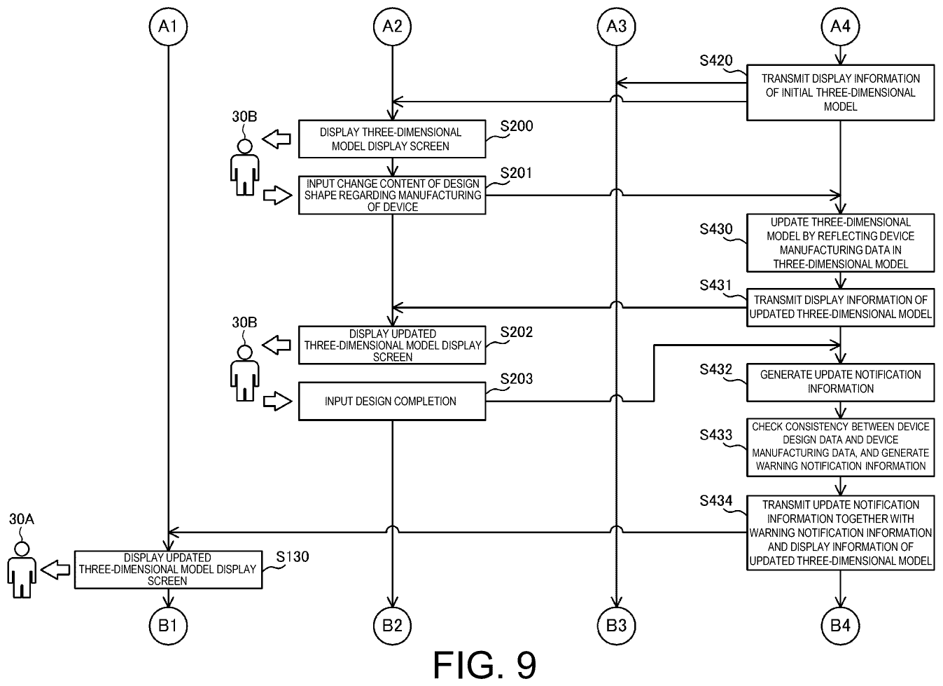

Next, in Step S420 illustrated in FIG. 9, when the display information generation unit 204 receives the instruction information from the terminal apparatus 3A, the display information generation unit 204 transmits the display information for displaying the initial three-dimensional model 57A to the terminal apparatus 3B and 3C used by the device manufacturing designer 30B and the device connection designer 30C, respectively, selected in the designer selection region 62.

Next, in Step S200, when the terminal apparatus 3B receives the display information from the device design assistance apparatus 2, the terminal apparatus 3B displays the three-dimensional model display screen (not shown) based on the display information. Then, the device manufacturing designer 30B visually recognizes the initial three-dimensional model 57A displayed on the three-dimensional model display screen. When the device manufacturing designer 30B inputs, for example, the weld lines 110a and 110b and the plate thickness of the vessel main body 110 as the change content of the design shape regarding the manufacturing of the pressure vessel 11, in Step S201, the terminal apparatus 3B transmits instruction information that is based on the input operation to the device design assistance apparatus 2.

Next, in Step S430, when the first model update unit 202 receives the instruction information from the terminal apparatus 3B as the device manufacturing data 55, the first model update unit 202 updates the three-dimensional model 57A by reflecting the device manufacturing data 55 in the three-dimensional shape, and registers the updated three-dimensional model 57B in the plant design database 5.

Next, in Step S431, the display information generation unit 204 generates display information for displaying the updated three-dimensional model 57B generated by the first model update unit 202, and transmits the display information to the terminal apparatus 3B. Then, in Step S202, the terminal apparatus 3B displays a three-dimensional model display screen 6B based on the display information.

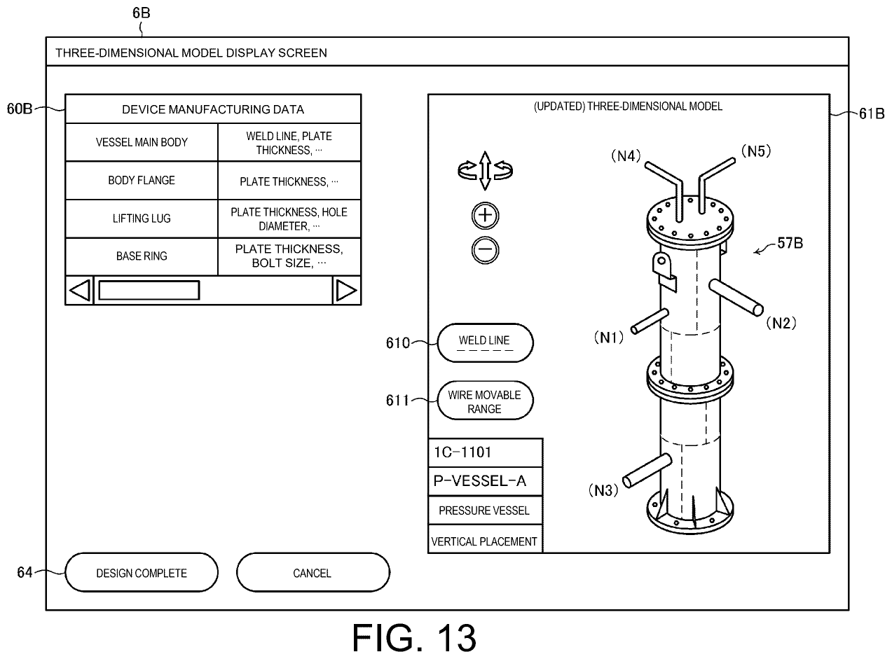

FIG. 13 is a view for illustrating an example of the three-dimensional model display screen 6B displaying the updated three-dimensional model 57B updated based on the device manufacturing data 55. The three-dimensional model display screen 6B includes a data display region 60B for displaying the device manufacturing data 55, a model display region 61B for displaying the updated three-dimensional model 57B, and a design completion button 64 for reporting the fact that the design by the device manufacturing designer 30B has been completed.

The model display region 61B is formed similarly to the model display region 61A, and includes the weld line button 610 and the wire movable range button 611. FIG. 13 shows the weld lines 110a and 110b (broken lines) displayed in superimposition with the three-dimensional shape of the pressure vessel 11 when the weld line button 610 is pressed. The data display region 60B may be capable of displaying data other than the device manufacturing data 55, or may be capable of displaying each diagram forming the plant design information 50. Further, the data display region 60B may allow correction of the change content of the design shape regarding the manufacturing of the pressure vessel 11.

The device manufacturing designer 30B visually recognizes the shape of the pressure vessel 11 displayed in the model display region 61B of the three-dimensional model display screen 6B. Then, when the device manufacturing designer 30B inputs the fact that the design for the manufacturing of the pressure vessel 11 has been completed through use of the design completion button 64, in Step S203, the terminal apparatus 3B transmits instruction information that is based on the input operation to the device design assistance apparatus 2.

Next, in Step S432, when the notification information generation unit 205 receives the instruction information from the terminal apparatus 3B, the notification information generation unit 205 generates update notification information for notifying the terminal apparatus 3A of the change content included in the device manufacturing data 55. Then, in Step S433, the notification information generation unit 205 checks the data consistency between the device design data 54 and the device manufacturing data 55, and, when there is no consistency, generates warning notification information for warning the terminal apparatus 3A of this fact. Next, in Step S434, the notification information generation unit 205 transmits, to the terminal apparatus 3A, the update notification information together with the warning notification information (when the warning notification information is generated in Step S433) and the display information for displaying the updated three-dimensional model 57B. The warning notification information may be transmitted not only to the terminal apparatus 3A but also to the terminal apparatus 3B and 3C.

Then, in Step S130, when the terminal apparatus 3A receives the update notification information, the warning notification information, and the display information from the device design assistance apparatus 2, the terminal apparatus 3 A performs notification of the change content based on the update notification information and warning based on the warning notification information (when the warning notification information is generated in Step S433), and displays the three-dimensional model display screen (not shown) including the updated three-dimensional model 57B based on the display information.

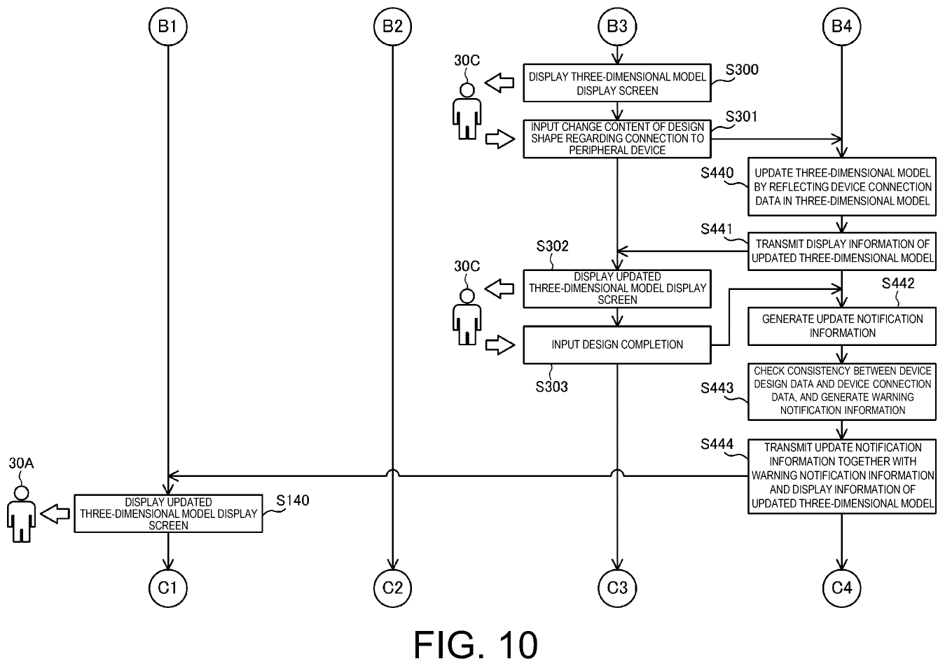

Meanwhile, in Step S300 illustrated in FIG. 10, when the terminal apparatus 3C receives the display information from the device design assistance apparatus 2, the terminal apparatus 3C displays the three-dimensional model display screen (not shown) based on the display information. Then, the device connection designer 30C visually recognizes the initial three-dimensional model 57A displayed on the three-dimensional model display screen (which may be the updated three-dimensional model 57B when the initial three-dimensional model 57A has been updated in Step S430). For example, when the device connection designer 30C inputs the nozzle position of each nozzle 111 as the change content of the design shape regarding the connection to the peripheral device of the pressure vessel 11, in Step S301, the terminal apparatus 3C transmits instruction information that is based on the input operation to the device design assistance apparatus 2.

Next, in Step S440, when the second model update unit 203 receives the instruction information from the terminal apparatus 3C as the device connection data 56, the second model update unit 203 updates the initial three-dimensional model 57A (which may be the updated three-dimensional model 57B when the initial three-dimensional model 57A has been updated in Step S430) by reflecting the device connection data 56 in the three-dimensional shape, and registers the updated three-dimensional model 57C in the plant design database 5.

Next, in Step S441, the display information generation unit 204 generates display information for displaying the updated three-dimensional model 57C generated by the second model update unit 203, and transmits the display information to the terminal apparatus 3C. Then, in Step S302, the terminal apparatus 3C displays a three-dimensional model display screen 6C based on the display information.

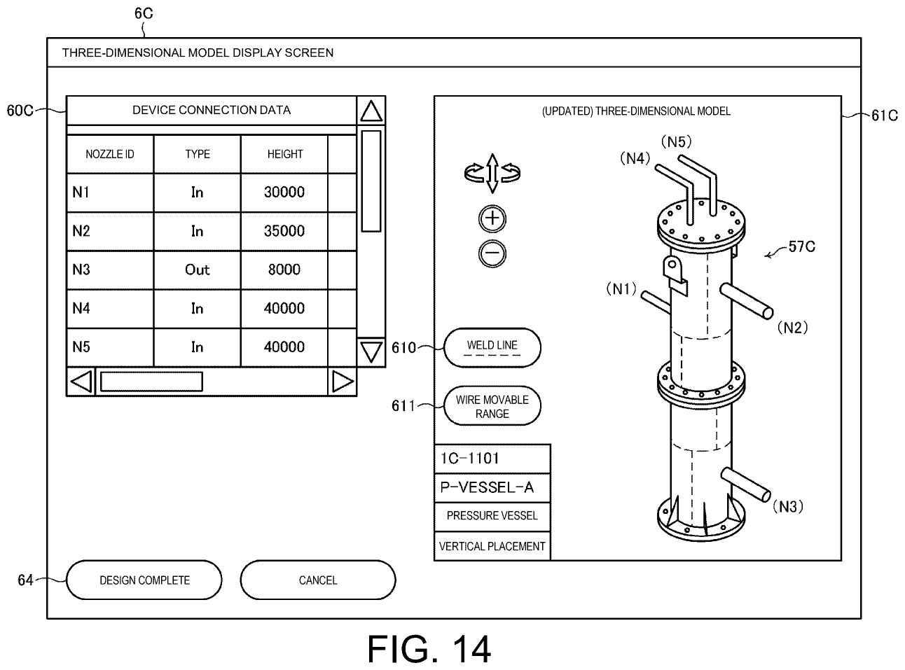

FIG. 14 is a view for illustrating an example of the three-dimensional model display screen 6C displaying the updated three-dimensional model 57C updated based on the device connection data 56. FIG. 15 is a view for illustrating an example of the three-dimensional model display screen 6C (model display region 61C) displaying the wire movable range 612. The three-dimensional model display screen 6C includes a data display region 60C for displaying the device connection data 56, a model display region 61C for displaying the updated three-dimensional model 57C, and a design completion button 64 for reporting the fact that the design by the device connection designer 30C has been completed.

The model display region 61C is formed similarly to the model display regions 61A and 61B, and includes the weld line button 610 and the wire movable range button 611. FIG. 14 shows the weld lines 110a and 110b by broken lines. The weld lines 110a and 110b are displayed in superimposition with the three-dimensional shape of the pressure vessel 11 when the weld line button 610 is pressed. FIG. 15 shows the wire movable range 612 which is displayed in superimposition with the three-dimensional shape of the pressure vessel 11 when the wire movable range button 611 is pressed. The data display region 60C may be capable of displaying data other than the device connection data 56, or may be capable of displaying each diagram forming the plant design information 50. Further, the data display region 60C may allow correction of the change content of the design shape regarding the connection to the peripheral device of the pressure vessel 11.

The device connection designer 30C visually recognizes the shape of the pressure vessel 11 displayed in the model display region 61C of the three-dimensional model display screen 6C. Then, when the device connection designer 30C inputs the fact that the design for the connection to the peripheral device of the pressure vessel 11 has been completed through use of the design completion button 64, in Step S303, the terminal apparatus 3C transmits instruction information that is based on the input operation to the device design assistance apparatus 2.

Next, in Step S442, when the notification information generation unit 205 receives the instruction information from the terminal apparatus 3C, the notification information generation unit 205 generates the update notification information for notifying the terminal apparatus 3A of the change content included in the device connection data 56. Then, in Step S443, the notification information generation unit 205 checks the data consistency between the device design data 54 and the device connection data 56, and, when there is no consistency, generates warning notification information for warning the terminal apparatus 3A of this fact. Next, in Step S444, the notification information generation unit 205 transmits, to the terminal apparatus 3A, the update notification information together with the warning notification information (when the warning notification information is generated in Step S443) and the display information for displaying the updated three-dimensional model 57C. The warning notification information may be transmitted not only to the terminal apparatus 3A but also to the terminal apparatus 3B and 3C.

Then, in Step S140, when the terminal apparatus 3A receives the update notification information, the warning notification information, and the display information from the device design assistance apparatus 2, the terminal apparatus 3 A performs notification of the change content based on the update notification information and warning based on the warning notification information (when the warning notification information is generated in Step S443), and displays the three-dimensional model display screen (not shown) including the updated three-dimensional model 57C based on the display information.

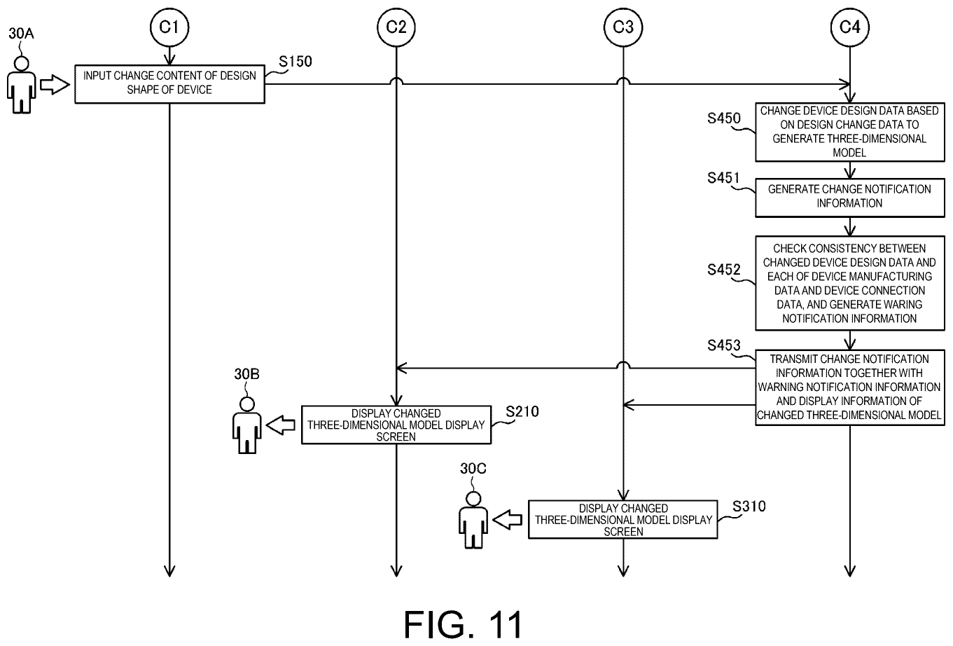

Further, in Step S150 illustrated in FIG. 11, for example, when the structural designer 30A inputs the change content of the design shape of the pressure vessel 11 (for example, the plate thickness of the vessel main body 110) as the input operation on the three-dimensional model display screen 6A illustrated in FIG. 12, the terminal apparatus 3A transmits instruction information that is based on the input operation to the device design assistance apparatus 2.

Next, in Step S450, when the model generation unit 201 receives the instruction information from the terminal apparatus 3A as the design change data, the model generation unit 201 changes the device design data 54 based on the design change data. Then, the model generation unit 201 generates the three-dimensional model 57 of the pressure vessel 11 based on the changed device design data 54, and registers the changed three-dimensional model 57 in the plant design database 5.

Next, in Step S451, the notification information generation unit 205 generates the change notification information for notifying the terminal apparatus 3B and 3C of the change content included in the design change data. Then, in Step S452, the notification information generation unit 205 checks the data consistency between the changed device design data 54 and each of the device manufacturing data 55 and the device connection data 56, and, when there is no consistency, generates the warning notification information for warning the terminal apparatus 3B and 3C of this fact. Next, in Step S453, the notification information generation unit 205 transmits, to the terminal apparatus 3B and 3C, the change notification information together with the warning notification information (when the warning notification information is generated in Step S452) and the display information for displaying the changed three-dimensional model 57. The warning notification information may be transmitted also to the terminal apparatus 3A.

Then, in Step S210, when the terminal apparatus 3B receives the change notification information, the warning notification information, and the display information from the device design assistance apparatus 2, the terminal apparatus 3B performs notification of the change content based on the change notification information and warning based on the warning notification information (when the warning notification information is generated in Step S452), and displays the three-dimensional model display screen (not shown) including the changed three-dimensional model 57 based on the display information. The device manufacturing designer 30B inputs the change content of the design shape as required on the three-dimensional model display screen, but the processing in this case is similar to that in Step S201 and the subsequent steps, and hence description thereof is omitted.

Further, in Step S310, when the terminal apparatus 3C receives the change notification information, the warning notification information, and the display information from the device design assistance apparatus 2, the terminal apparatus 3C performs notification of the change content based on the change notification information and warning based on the warning notification information (when the warning notification information is generated in Step S452), and displays the three-dimensional model display screen (not shown) including the changed three-dimensional model 57 based on the display information. The device connection designer 30C inputs the change content of the design shape as required on the three-dimensional model display screen, but the processing in this case is similar to that in Step S301 and the subsequent steps, and hence description thereof is omitted.

The series of processing steps described above are performed on each device 100 so that the contents of the design work performed by the plurality of designers 30A to 30C on each device 100 are consolidated to the three-dimensional model 57 of each device 100. In the series of processing steps described above, Step S400 and Step S401 correspond to a structural calculation step, Step S410, Step S411, and Step S450 correspond to a model generation step, Step S430 corresponds to a first model update step, Step S440 corresponds to a second model update step, Step S412, Step S420, Step S431, and Step S441 correspond to a display information generation step, and Step S432 to Step S434, Step S442 to Step S444, and Step S451 to S453 correspond to a notification information generation step.

As described above, according to the device design assistance apparatus 2 and the device design assistance method of this embodiment, in the model generation unit 201 (model generation step), the three-dimensional model 57A is generated based on the device design data 54 including the design shape relating to the structural design of the device 100. In the first model update unit 202 (first model update step), the three-dimensional model 57B is updated based on the device manufacturing data 55 including the change content regarding the manufacturing of the device 100. In the second model update unit 203 (second model update step), the three-dimensional model 57C is updated based on the device connection data 56 including the change content regarding the connection to the peripheral device. Thus, the contents of the design work performed additionally or gradually by the plurality of designers 30A to 30C regarding the structural design of the device 100, the manufacturing of the device 100, and the connection to the peripheral device can be sequentially consolidated to the three-dimensional models 57A to 57C.

### OTHER EMBODIMENTS

The present invention is not limited to the above-mentioned embodiment, and various modifications can be made thereto without departing from the gist of the present invention. Further, all of the embodiments thus obtained are included in the technical idea of the present invention.

In the above-mentioned embodiment, description is given assuming that the functions of the respective units included in the device design assistance apparatus 2 are implemented by one apparatus, but the functions of the respective units may be distributed to a plurality of apparatus to be implemented by the plurality of apparatus. Further, the control units of the terminal apparatus 3A to 3C may execute the device design assistance program 210 to function as the device design assistance apparatus 2.

In the above-mentioned embodiment, description has been given of a case in which, as illustrated in FIG. 2, the device design assistance apparatus 2 includes the first model update unit 202 and the second model update unit 203, but the device design assistance apparatus 2 may include only one of the first model update unit 202 or the second model update unit 203. In this case, the device design assistance apparatus 2 may perform only executable steps in the flow charts illustrated in FIG. 8 to FIG. 11.

In the above-mentioned embodiment, description has been given of a case in which, as illustrated in FIG. 6 and FIG. 8 to FIG. 11, the device design assistance apparatus 2 first receives the device manufacturing data 55 and then receives the device connection data 56 so that the three-dimensional model 57 is sequentially updated, but the order and the number of times to receive the device manufacturing data 55 and the device connection data 56 are not limited to the examples of the above-mentioned embodiment. At this time, the change contents with respect to the design shape included in the device manufacturing data 55 and the device connection data 56 are also not limited to the examples of the above-mentioned embodiment. For example, the device design assistance apparatus 2 may first receive the device connection data 56 and then receive the device manufacturing data 55 so that the three-dimensional model 57 is sequentially updated. Further, the device design assistance apparatus 2 may receive at least one of the device manufacturing data 55 or the device connection data 56 a plurality of times so that the three-dimensional model 57 is updated each time. For example, the device design assistance apparatus 2 may receive, as the first stage, the device manufacturing data 55 for setting the weld line 110a along the radial direction to update the three-dimensional model 57, receive, as the second stage, the device connection data 56 for changing the nozzle position to update the three-dimensional model 57, and receive, as the third stage, the device manufacturing data 55 for setting the weld line 110b along the axial direction so as to avoid the nozzle position to update the three-dimensional model 57. Moreover, the device design assistance apparatus 2 may receive the device manufacturing data 55 from each of a plurality of device manufacturing designers 30B to update the three-dimensional model 57, or may receive the device connection data 56 from each of a plurality of device connection designers 30C to update the three-dimensional model 57.

In the above-mentioned embodiment, description has been given of a case in which the notification information generation unit 205 of the device design assistance apparatus 2 checks the consistency after the three-dimensional model 57 is updated based on the device manufacturing data 55 and the device connection data 56, but the consistency may be checked at any other timing. For example, the consistency may be checked before the three-dimensional model 57 is updated, or checked before the device manufacturing data 55 and the device connection data 56 are received.

In the above-mentioned embodiment, description has been given of a case in which the plant design assistance system 1 operates in accordance with the flow charts illustrated in FIG. 8 to FIG. 11, but the execution order of each step may be changed as appropriate, or some of the steps may be omitted.

### REFERENCE SIGNS LIST

1. plant design assistance system, 2. device design assistance apparatus,
3A to 3C. terminal apparatus, 4. network,
5. plant design database, 6A to 6C. three-dimensional model display screen,
10. plant, 11. pressure vessel, 20. control unit, 21. storage unit,
22. communication unit, 23. input unit, 24. display unit, 30A. structural designer,
30B. device manufacturing designer, 30° C. device connection designer,
50. plant design information, 51. structural design diagram, 52. structural design information,
53. device basic data, 54. device design data,
55. device manufacturing data, 56. device connection data,
57, 57A to 57C. three-dimensional model,
60A to 60C. data display region, 61A to 61C. model display region,
62. designer selection region, 63. design request button, 64. design completion button,
100. device, 101. piping, 110. vessel main body, 110a, 110b. weld line,
111. nozzle, 112. body flange,
113. lifting lug, 114. base ring,
200. structural calculation unit, 201. model generation unit,
202. first model update unit, 203. second model update unit,
204. display information generation unit, 205. notification information generation unit,
210. device design assistance program, 612. wire movable range

1. A device design assistance method, comprising:
a model generation step of generating, after receiving a device design data including a design shape relating to a structural design of a device to be installed in a plant, a three-dimensional model representing a shape of the device based on the device design data;
a first model update step of updating, after receiving a device manufacturing data including a change content with respect to the design shape regarding manufacturing of the device, the three-dimensional model by reflecting the device manufacturing data in the shape; and
a second model update step of updating, after receiving a device connection data including a change content with respect to the design shape regarding a connection to a peripheral device installed around the device in the plant, the three-dimensional model by reflecting the device connection data in the shape.

2. The device design assistance method according to claim 1, wherein
the device is a pressure vessel including a plurality of nozzles,
wherein the device manufacturing data includes at least one of a weld line of the pressure vessel or a plate thickness of the pressure vessel, and
wherein the device connection data includes a nozzle position indicating a position of each of the plurality of nozzles provided in the pressure vessel for connection to the peripheral device.

3. The device design assistance method according to claim 2, wherein
the device design data includes a nozzle positional relationship which determines a relative positional relationship between specific nozzles out of the plurality of nozzles.

4. The device design assistance method according to claim 1, further comprising:
notification information generation step of generating an update notification information and a change notification information,
the update notification information being provided to notify a provider of the device design data of the change content included in the device manufacturing data or the device connection data,
the change notification information being provided to notify a provider of at least one of the device manufacturing data or the device connection data of a change content made when the design shape is changed in the structural design.

5. The device design assistance method according to claim 4, wherein the notification information generation step includes:
checking consistency of data among the device design data, the device manufacturing data, and the device connection data; and
generating, when there is no consistency, a warning notification information for warning a provider of the device design data, the device manufacturing data, or the device connection data of a fact that there is no consistency.

6. The device design assistance method according to any claim 1, further comprising:
a display information generation step of generating a display information for displaying, on a display screen, the three-dimensional model generated in the model generation step or the three-dimensional model updated in at least one of the first model update step or the second model update step.

7. The device design assistance method according to claim 6, wherein the device design data includes:
a hoisting hardware position, indicating a position of a hoisting hardware for use in hoisting the device with a wire member when the device is installed, and
a wire movable range, indicating a range in which the wire member is movable with reference to the hoisting hardware position,
wherein the display information generation step includes: generating a display information for displaying the shape and the wire movable range in a distinguishable manner on the display screen.

8. A device design assistance method, comprising:
a model generation step of generating, after receiving a device design data including a design shape relating to a structural design of a device to be installed in a plant, a three-dimensional model representing a shape of the device based on the device design data; and
a first model update step of updating, after receiving a device manufacturing data including a change content with respect to the design shape regarding manufacturing of the device, the three-dimensional model by reflecting the device manufacturing data in the shape.

9. (canceled)

10. A device design assistance apparatus, comprising:
a model generation unit, configured to generate, after receiving a device design data including a design shape relating to a structural design of a device to be installed in a plant, a three-dimensional model representing a shape of the device based on the device design data;
a first model update unit, configured to update, after receiving a device manufacturing data including a change content with respect to the design shape regarding manufacturing of the device, the three-dimensional model by reflecting the device manufacturing data in the shape; and
a second model update unit, configured to update, after receiving a device connection data including a change content with respect to the design shape regarding a connection to a peripheral device installed around the device in the plant, the three-dimensional model by reflecting the device connection data in the shape.
